(19) United States
(12) Patent Application Publication
(10) Pub. No.: US 2012/0174525 A1
(43) Pub. Date: Jul. 12, 2012

(54) CONSTRUCTION FASTENING AND LOCATING SYSTEM AND METHOD

(75) Inventors: Foster D. Hinshaw, Cambridge, MA (US); William J. Fosnight, Saratoga Springs, NY (US)

(73) Assignee: Dunmow Systems Corporation, Cambridge, MA (US)

(21) Appl. No.: 13/324,731

(22) Filed: Dec. 13, 2011

Related U.S. Application Data
(60) Provisional application No. 61/422,508, filed on Dec. 13, 2010.

(51) Int. Cl. B25C 5/00; E04B 1/38

(52) U.S. Cl. 52/741.1; 52/749.1

(57) ABSTRACT

A construction fastening system adapted to fasten sheathing to framing with one or more fasteners. The fastening system has a frame and a fastening actuator coupled to the frame. The fastening actuator has a fastener reservoir portion and a fastener insertion portion. A position detector is coupled to the frame, the position detector connected to a controller, the position detector adapted to detect a position of the system. A trigger is coupled to the fastening actuator, the trigger coupled to the controller. The fastening actuator is adapted to insert a fastener from the reservoir into the sheathing upon actuation of the trigger. The controller is adapted to actuate the trigger upon detection of a predetermined change in the position of the system.

### RELATED APPLICATIONS

This application claims the benefit of and priority from U.S. Provisional Patent Application Ser. No. 61/422,508 Entitled “CONSTRUCTION FASTENING AND LOCATING SYSTEM AND METHOD” and filed on Dec. 13, 2010 which is hereby incorporated by reference herein in its entirety.

### BACKGROUND

1. Field

The disclosed embodiments relate to a construction fastening and locating system and method and, more particularly, to a residential or commercial construction fastening and locating system and method.

2. Brief Description of Earlier Developments

Home or commercial construction projects often involve framed and sheathed construction. Typical construction involves a dimensioned plan and a specification reflecting the desired construction provided to carpenters or a framing crew. The carpenters or a framing crew typically frame the floors, walls and roof by first assembling stick portions where the stick portions may include joists, studs, rafters or otherwise. Upon completion of all or a portion of a given stick portion, sheathing may be applied, for example, to all or a portion of a floor, wall or roof stick portion. The sheathing is typically cut to size if needed, placed in position and nailed to the given stick portion. The nailing is typically done manually with the assistance of a pneumatic or gas operated nailer. As such, the nailing is very labor intensive and subject to errors and inconsistencies as, in many cases, the worker is blind to the stick portion that the given piece of sheathing is being nailed to and is not capable of precise placement. Further, with respect to the sticks, stick portions, nails and fasteners or any component or portion of the construction, tracking of progress, certification of completion and providing location of the components is typically done by a manual process. As such, the construction project is subject to errors and inefficiencies associated with lack of coordination, communication and efficient resource allocation. Accordingly, there is a desire to reduce errors and inconsistencies and to improve coordination, communication and efficient resource allocation.

### BRIEF DESCRIPTION OF THE DRAWINGS

The foregoing aspects and other features of the exemplary embodiments are explained in the following description, taken in connection with the accompanying drawings, wherein:

FIG. 1 is an isometric view of a construction fastening system and user;

FIG. 2 is an isometric view of a construction fastening system;

FIG. 3 is an exploded isometric view of a construction fastening system;

FIG. 4 is a top view of a construction fastening system;

FIG. 5 is a rear view of a construction fastening system;

FIG. 6 is a side view of a construction fastening system;

FIG. 7 is a side view of a construction fastening system;

FIG. 8 is a diagram of a locating and tracking system; and

FIG. 9 is a flow diagram showing a method of building a structure at a job site.

### DETAILED DESCRIPTION OF THE EXEMPLARY EMBODIMENT(S)

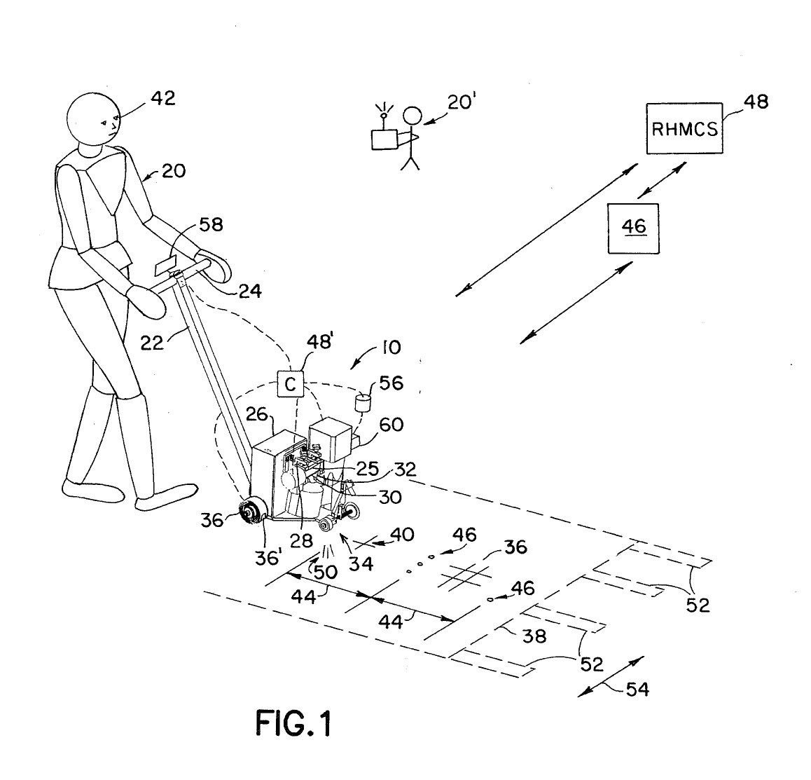

Referring to FIG. 1, there is shown, an isometric view of a construction fastening and locating system 10 and user 20 suitable for use in residential, commercial or other construction and incorporating features in accordance with an exemplary embodiment. Although the present embodiments will be described with reference to the embodiments shown in the drawings, it should be understood that the present embodiments can be embodied in many alternate forms of embodiments. In addition, any suitable size, shape or type of elements or materials could be used. By way of example, although system 10 will be described with respect to framed and sheathed components of lumber, any suitable components, for example, metal, polymer, composite, masonry or otherwise may be used. Further, system 10 may be adapted to any suitable fastener, adhesive or other suitable application. Further, system 10 will be described with respect to framed and sheathed components, other components prior, during or subsequent to framing may be applied to the present embodiments. By way of example, interior or exterior trim components, siding or roofing components, hybrid sheathing and siding components, kitchen and bath components, wall finishing components such as sheetrock or otherwise, interior or exterior masonry and supporting structures or other suitable component part or subassembly may be used in conjunction with system 10. System 10, LPS 60 and the disclosed embodiments are suitable for use with a control system or RHMCS as disclosed in U.S. patent application Ser. No. 13/178,344 filed Jul. 7, 2011 entitled “Construction Control System” which is hereby incorporated by reference in its entirety. Further, system 10, LPS 60 and the disclosed embodiments are suitable for use with a stick machine as disclosed U.S. patent application entitled “Automated Stick Frame System” having Ser. No. 13/178,138 and filed Jul. 7, 2011 which is hereby incorporated by reference herein in its entirety. Further, system 10, LPS 60 and the disclosed embodiments are suitable for use with a method and apparatus as disclosed U.S. Provisional Patent Application Ser. No. 61/422,476 and file date Dec. 13, 2010 entitled “Frame Construction Method and Apparatus” which is hereby incorporated by reference herein in its entirety. Further, system 10, LPS 60 and the disclosed embodiments are suitable for use with a method and apparatus as disclosed U.S. Provisional Patent Application Ser. No. 61/422,501 and filed on Dec. 13, 2010 entitled “Construction Material Handling Method and Apparatus” which is hereby incorporated by reference herein in its entirety.

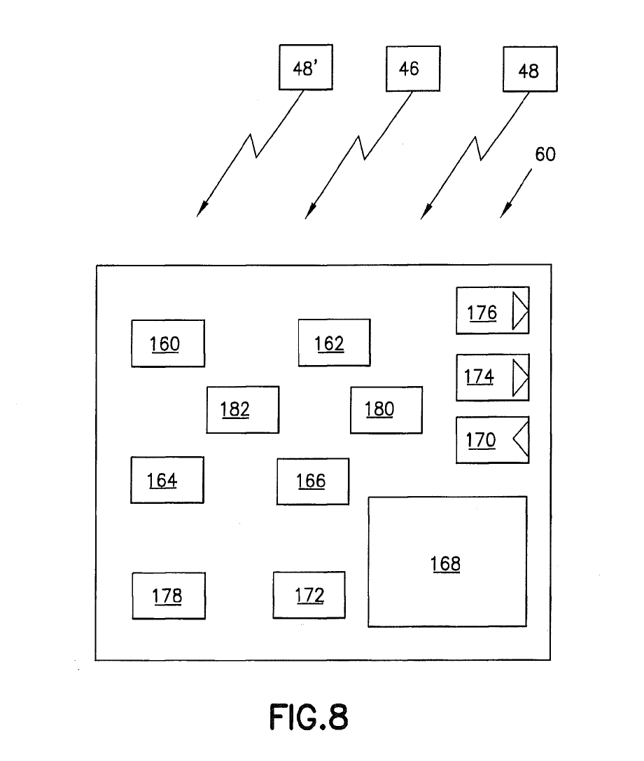

In the embodiment shown in FIG. 1, user 20 may be any suitable user and the system may be sized for any suitable user, for example a 95^{th} percentile North American male. In alternate embodiments, the system may be adjustable to accommodate users of different sizes. System 10 has push handle 22 with trigger 24 where trigger 24 may be used to enable or disable fastening. System 10 has nail gun 25 fastened to frame 26. In the embodiment shown, system 10 is described with respect to nail gun 25. In alternate embodiments, any suitable fastening actuator 25 may be provided. In the embodiment shown, fastening actuator 25 has a fastener reservoir portion and a fastener insertion portion where the fastening actuator 25 may insert a fastener from the reservoir into the sheathing upon actuation of trigger 32. In the embodiment shown, nail gun 25 may be any suitable and commercially available and/or off the shelf nail gun or fastening device. Nail gun 25 may be arranged such that reloading of nails is accomplished without the removal of nail gun 25. Nail gun 25 may be clamped to frame 26 with clamp 28 such that clamp 28 may provide for reversible mounting, for example, nail gun 25 may be mounted facing right, left or any suitable attitude or location. In alternate embodiments, nail gun 25 may be mounted in slots with hand screws or otherwise to allow for Manual vertical adjustment. In alternate embodiments, a manual lever may be provided to vertically adjust the height of nail gun 25 with respect to the surface being nailed. In the embodiment shown, air actuated plunger 30 may be provided driving nail gun trigger 32. Here, trigger 32 may be coupled to the controller via plunger 30 or otherwise where the controller may selectively actuate the trigger, for example, wherein the controller actuates the trigger upon detection of a predetermined change in the position of the system or otherwise. In alternate embodiments, any suitable actuation responsive to trigger 24 and/or controller 48′ may be provided to actuate gun or fastening member 25. In the embodiment shown, controller 48′ is provided having a processor and memory to perform functions such as the placement of fasteners at a given interval. In alternate embodiments, controller 48′ may be mechanical in nature to perform functions such as the placement of fasteners at a given interval or otherwise where mechanical controller 48′ may, for example, may be provided having a mechanism slaved off of wheels 36 to trigger gun 25 at a given interval or otherwise. In the embodiment shown, nail gun 25 is shown as a pneumatic nail gun. In alternate embodiments, any suitable fastening device may be used, for example, a gas or electric or otherwise operated gun, a screw driver or any suitable fastening device. In further alternate embodiments, nailer 25 may be pneumatic, gas operated or otherwise and may be self contained having an on board compressor or fuel source and on board fasteners that are automatically loaded. Slide shoe 34 is shown such that when slide shoe 34 contacts surface 36 of sheathing 38, the proper position of the driving head of nail gun 25 with respect to sheathing or floor 38 is provided. Casters 36 are shown as four inch casters. In alternate embodiments, any suitable size may be provided. In alternate embodiments, a vacuum area may be provided to properly position the driving head of nail gun 24 with respect to sheathing or floor 38 and to maintain the appropriate gap. Further, a vacuum area may be provided to provide adhesion of system 10 to sheathing 36, for example, where sheathing 36 is at an angle, for example, inverted, vertical or at a pitch of a roof or otherwise. Laser line or cross hair 40 may be provided in line with the nail gun path or at some offset to allow user 20 to visually 42 see where the system 10 will be providing fasteners. In the embodiment shown, user 20 in conjunction with handle 22 guides the system 10 via manual guidance. In alternate embodiments, as will be described below, automatic or semi automatic guidance may be provided. In operation, user 20 depresses trigger 24 where system 10 fires a nail and where subsequent nails are fired at a preset interval 44 where the interval 44 may be fixed or adjustable by the user 20 or by a local 46 or remote 48 server or controller. Interval 44 may be constant between fasteners 46 (to be placed) or may be any suitable sequence of intervals. In the embodiment shown, holding trigger 24 down automatically fires nails where an encoder 36′ on a wheel 36 or wheels in conjunction with a local controller 48 measures distance, in one or more directions. For example, if bi-directional or quadrature encoder 36′ is provided on opposing wheels or casters 36, controller 48′ may determine both distance, direction and how straight or curved system 10 tracks. As such, the controller 48′ may determine if the system 10 has been moved forward or backward and make adjustments to keep the interval 44 as specified. In alternate embodiments, encoder 36′ may be provided on a separate wheel or may be any suitable position detection device, for example, a camera, optical detector or any suitable position detection device. Tracking device or sensing device 50 may be provided to track a fiducial or line on sheathing 36 or to sense stud or joist 52 to keep the system 10 centered on a joist 52 where the system 10 may be manually steered or steered by the local controller 48′ where controller 48′ senses an offset from a desired path and corrects by differentially driving wheels 36 or otherwise steering system 36 or otherwise. Joist sensor 50 may be a capacitive sensor, ultrasonic sensor or any suitable sensor. In alternate embodiments, any suitable sensor may be provided, for example where a camera or other sensor detects marks or features, such as edges, to determine location and reference. System 10 may pivot or steer or alternately may have a slide and linear actuator which laterally moves the fastening portion 24 to track the joist 52. Alternately, the system may optically or otherwise track a chalk line, or sense some fiducial or lines on the sheathing or any suitable reference. Alternately, the system may sense other reference locations, such as edges, walls or known objects with in the construction site as a reference. System 10 may be autonomous and may remember previous locations and actions and may be data driven from a local 46, 48′ or remote 48 server or controller. In alternate embodiments, system 10 may be driven by a user 20 locally with the system 10 or may be driven with a user 20′ guiding or controlling the system, for example with a radio or remote control. System 10 may have an alarm or light tower 56 to indicate when an error, jam or otherwise occurs. System 10 may have a user interface 58 to indicate status, error type or jam type or where a problem exists and the remedy or any suitable information. Display 58 may further display data such as status, setting parameters or otherwise. Display 58 may have a user input that may be provided such as a keypad, buttons, voice interface or as a touch screen to allow a user 20 to reset parameters, clear errors or otherwise interface with the system. System 10 may be user driven or may be completely autonomous having access to data representing construction status, material location or other suitable data. In alternate embodiments, system 10 may find joists and fire nails or fasteners autonomously with or without access to plans, status or data and having appropriate sensors. For example, system 10 may be an autonomous vehicle for nails, where a user sets the interval to be nailed and sets the system on a first joist 52 and where the system 10 nails at the interval and automatically indexes a distance 54 to the next joist. By way of further example, system 10 may alternately have access to plans, construction status and personnel and material placement status and location and may manually, semi automatically or autonomously fasten sheathing 36 to joists 52 as the sheathing is placed and materials and personnel are cleared. In the embodiment shown, system 10 may quickly, accurately and ergonomically fasten sheathing—either floor, roof, wall or otherwise to joists, rafters studs or otherwise. Here, system 10 may be a manual, semi autonomous or autonomous vehicle that is controlled by the RHMCS 48 or alternately may be directed by an operator 20, 20′ or local onboard controller 48′ or local controller 46. A suitable example of RHMCS 48 is disclosed in U.S. Provisional Application Ser. No. 61/362,145 filed Jul. 7, 2010 which is hereby incorporated by reference in its entirety. Here, RHMCS 48 may be a Residential or Commercial Homebuilding Material Control System (RHMCS) 46 that may maintain item and location data real time for design, millwork and construction phases (real-time as-built). Location and/or status tracking device 60 may be affixed to system 10 or any device contributing to the completion of the structure including fabrication materials, fabricated assemblies, automation components, tools, personnel, ancillary materials, plumbing materials, electrical materials, HVAC materials, insulation, fasteners or any other suitable contributor to the completion of the structure. Here, the tracking devices may communicate with system 48 in a one or two way fashion, driving, for example, system 10 to the portion of the site needed or by way of further example, driving additional materials to the site based on completion status. As such, the tracking devices facilitate efficient completion of the structure. In alternate embodiments, more or less functions may be provided. Feedback into system 48 may include data transmitted from system 10 which may be on or off site, for example, status of task or position of system 10 from local position feedback system(s) as well as data transmitted from humans, for example, via a smart phone interface with location information. Positioning data within device 60 or otherwise may be captured by any suitable position system including gps, laser, bar code, OCR or any suitable scanner where the system may create a map space with partial or full content as required. For example, the position system may identify on site locations of “landmarks” and fiducials in map space where internal “GPS” systems confirm position and variances. In alternate embodiments, inertial or any other suitable position system, such as laser based systems may be provided. Further, in alternate embodiments, parallel positioning sensors may be used to “filter” spurious positioning signals. A database within control system 48 may be updated continuously with status and state data where a state model is updated as well. By recording installation and position, the construction project may be self certifying and not requiring a separate visual inspection, for example, self certification for wind load may be accomplished by recording and confirming nail positions, lubber type and location, adhesive application or any suitable data as required for a given certification. Such data may, for example, include type of nails, position, depth, spacing, grade of lumber or otherwise. The data may be routed to the database of system 48 to certify and record spacing or otherwise such that code compliance is ensured by the data set where the database may provide a compliance report to demonstrate certification with no or only partial inspection. The certification may apply to any or all aspects of the construction including lumber, joints, wiring, plumbing where the database is updated and if not to code, drives change in a bi-directional manner. In one embodiment, system 10 takes coordinates from the RHMCS 48 and verifies its position using LPS 60 as has been and will be described and with respect to FIG. 8. Once at a nailing location, system 10 fires Nails 46 using a pneumatic nail gun or other suitable fastening method in line with joists 52 where encoder 36′ on system 10 measures the distance traveled to ensure nails are fired at exactly the right spacing. As nails are fired, data associated with the nailing, travel or otherwise may be stored in controller 48′ and/or transmitted to RHMCS 48 or controller 46 for verification and certification purposes. In operation, system 10 may include sensor 50, for example, capacitive, ultrasonic or otherwise that verifies the position of the joist or stud 52 to ensure system 10 or fastening device 25 is travelling/fastening along the centerline or other desired location of joist, stud or rafter 52. In alternative embodiments, system 10 may include a bridge structure that provides a linear rail that nail gun 24 can linearly traverse. In yet another embodiment, system 10 may be operator driven with an extended handle resembling a push vacuum cleaner. In this embodiment, nail gun 25 is actuated to follow the line of the stud independently of the operator's guidance. For example, indicators, such as LED indicators on the handle 22 indicate to the operator 20 how they are tracking and provides course steering correction. In the case of gross mis-steering, for example, more than +/−6″ or otherwise, system 10 discontinues firing and is reset at the previous confirmed position. As such, steering of system 10 and gun 25 and location may need both fine and coarse settings. By way of example, a combination of inertial navigation, line or load marks and location device 60 may detect location within ½″ or less or otherwise. Further, land marks such as board edges, fiducial marks or features from the manufacturer or otherwise may provide coarse location with fine location being provided by sensing joists or otherwise. In alternate embodiments, other suitable indicators may be provided. For example, an LED may be provided to show what mode the nailer is in. Here, controller 48′ may be programmed to have a test mode where the indicator goes off to indicate where a nail would be fired without firing the nail(s) in test mode such that a user may take a dry run to test. In another alternate embodiment, an indicator may be provided to indicate that a misfire has occurred or where the system is out of nails or fasteners. Here, an acoustic sensor may be used with controller 48′ to detect the misfire and a brake may be applied by controller 48′ to prevent the user from further progressing without any fasteners or where a fastener was missed. In the embodiment shown, system 10 is shown having one nailer 25. In alternate embodiments, system 10 may have more than one nailer 25. In further alternate embodiments, more than one system 10 may be provided for redundancy and/or speed. In the embodiment shown, controller 48′ or LPS 60 may communicate with local controller 46 or remote controller or server 48. As such, system 10 may communicate status, progress or otherwise and may receive commands, data or otherwise such that system 10 and RHMCS 48 may be synchronized substantially in real time or periodically as required. An example of data includes downloading includes downloading of topography of wall or floor panels, joists or studs, nail or fastener spacing, materials or otherwise as needed from system 48. As a further example, land mark locations may be updated in real time to accurately determine a location. As a further example, when a nail is put in, system 10 may report back to RHMCS 48 that the action was complete. Alternately, system 10 may buffer data and update RHMCS 48 periodically. By way of further example, system software in RHMCS 48 or controller 46 may download an image or data of the construction site or tasks to be performed. As such, system 10 may or may not have to be connected to the system software continuously. Interacting with the local controller or system software 46, system 10 may know in real time what boards or panels or sheathing have been installed and interlocks may be provided to sense the material or otherwise where final positioning may be provided, for example, tracking a laser line or pattern on the construction site.

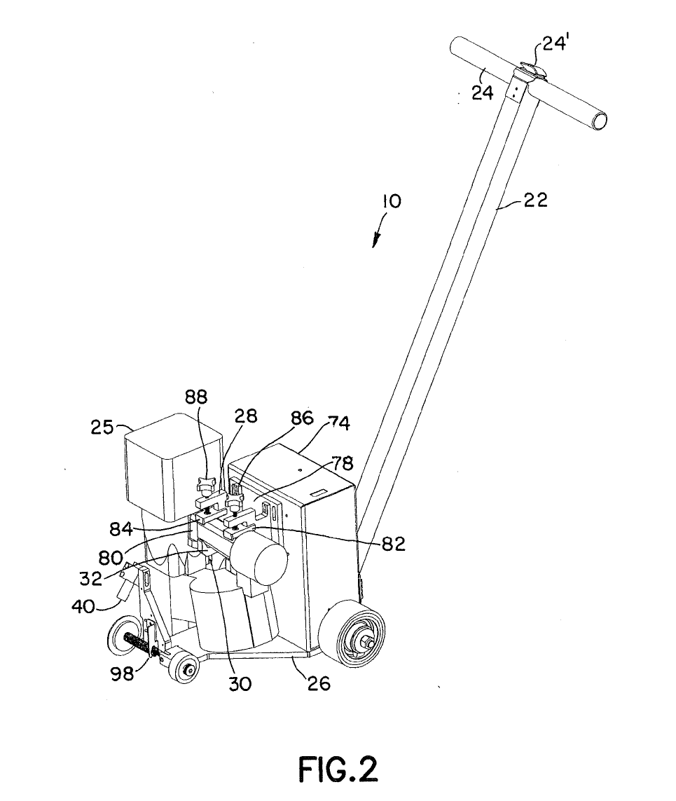

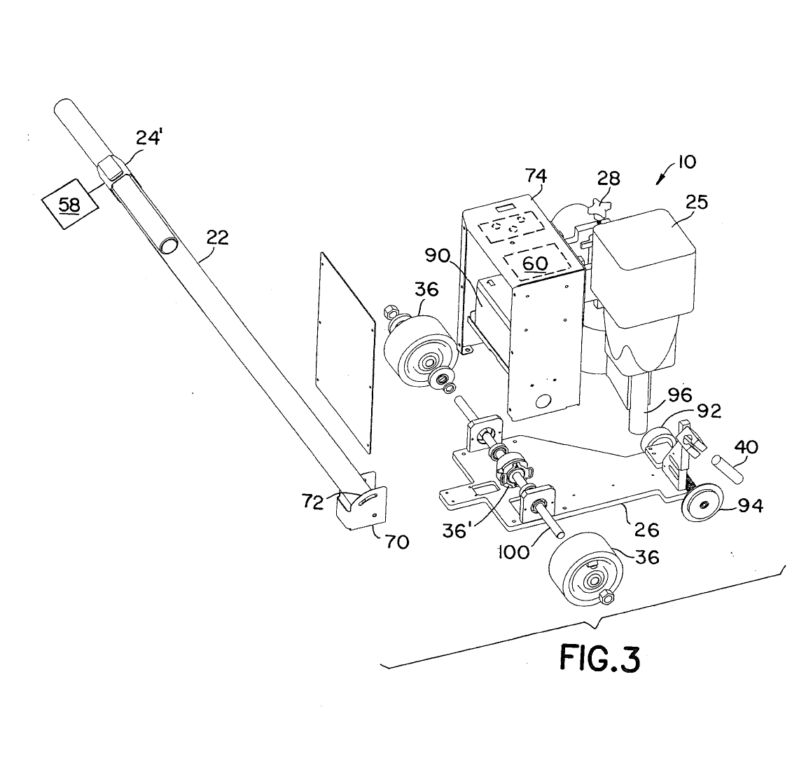

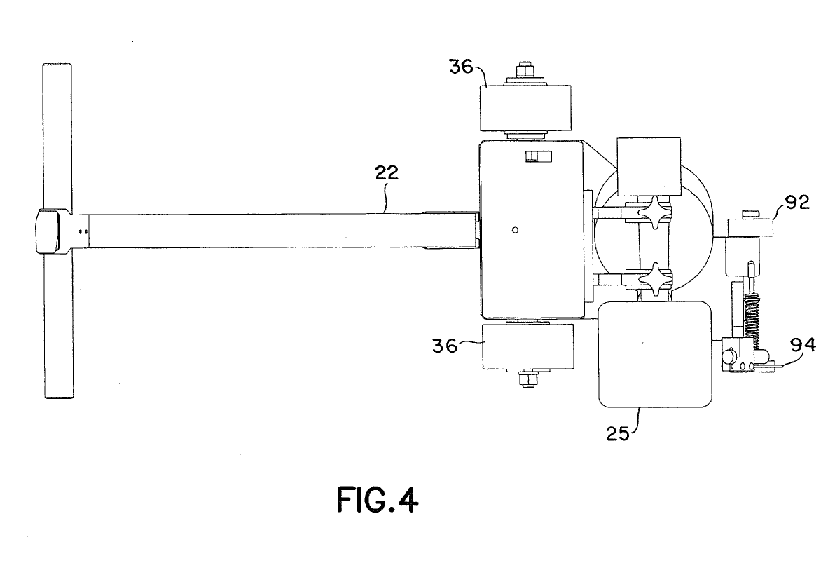

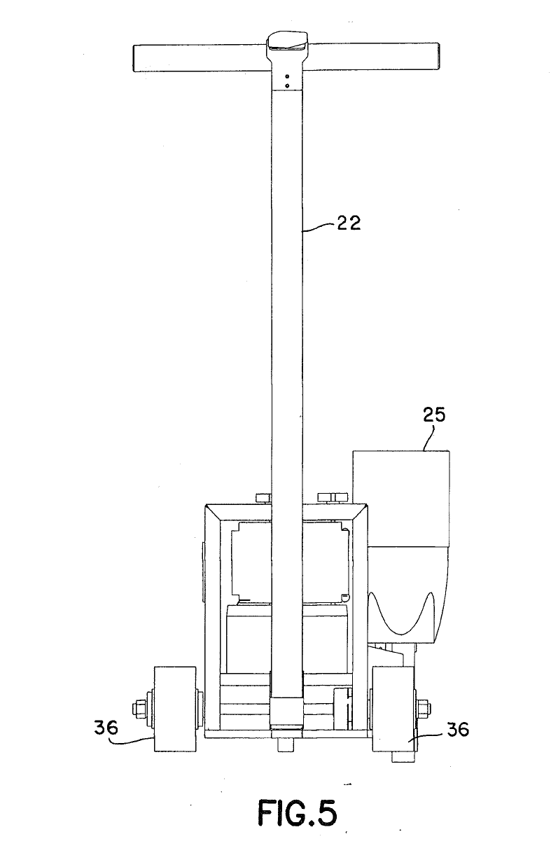

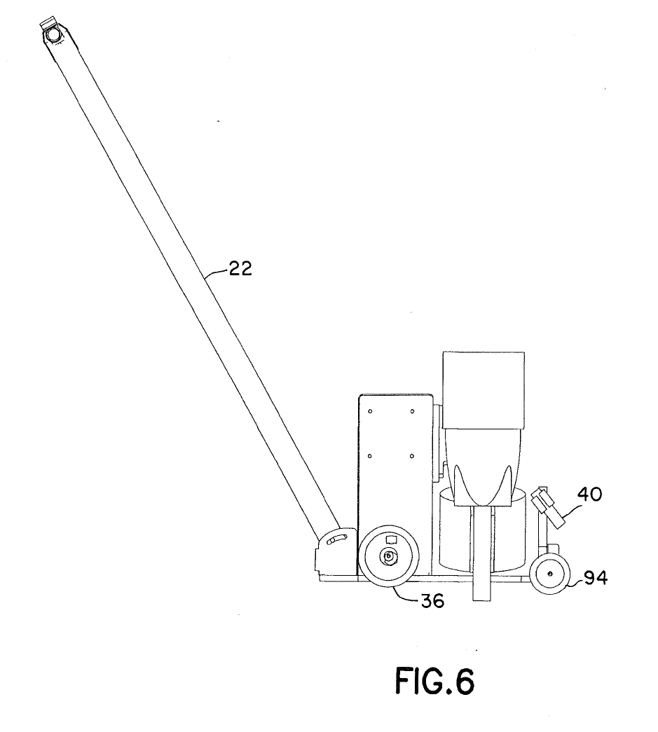

Referring now to FIG. 2, there is shown an isometric view of a construction fastening system 10. Referring also to FIG. 3, there is shown an exploded isometric view of a construction fastening system 10. Referring also to FIG. 4, there is shown a top view of a construction fastening system 10. Referring also to FIG. 5, there is shown a rear view of a construction fastening system 10. Referring also to FIG. 6, there is shown a side view of a construction fastening system 10. System 10 is shown having push handle 22 with trigger 24. Handle 22 is fastened to frame 26 with pivot housing 70. Handle 22 may be fixed or pivotable about housing 70 where fastener 72 may be provided to fix handle 22 with respect to housing 70 and frame 26. Alternately, trigger 24′ may be provided to actuate system 10. In alternate embodiments, one or more triggers, live man and/or dead man switches may be provided. System 10 has nail gun 25 fastened to frame 26 via housing 74. Nail gun 25 may be clamped to housing 74 with clamp 28 having C-members 78, 80, clamping members 82, 84 and clamp knobs 86, 88. Air actuated plunger 30 may be provided driving nail gun trigger 32. In the embodiment shown, nail gun 25 is shown as a pneumatic nail gun. In alternate embodiments, any suitable fastening device may be used, for example, a gas or electric or otherwise operated gun, a screw driver or any suitable fastening device. In further alternate embodiments, nailer 25 may be pneumatic, gas operated or otherwise and may be self contained having an on board compressor or fuel source and on board fasteners that are automatically loaded. Battery 90 may be provided to power controller 48′, LPS 60 and encoder 36′. Support wheel 92 is shown mounted to frame 26 where support wheel 92 ensures the proper position of the driving head 96 of nail gun 25 with respect to the sheathing or floor 38. Guide wheel 94 is shown in line or offset from the firing line of gun 25 and vertically adjustably mounted to frame 26 in slot 98. Casters 36 are shown mounted to frame 26 with shaft 100 and supporting bearings. Laser source 40 is shown line or cross hair 40 may be provided in line with the nail gun path or at some offset to allow user 20 to visually see where the system 10 will be providing fasteners. In alternate embodiments, for example where system 10 is autonomous or semi autonomous, laser 40 may be replaced with a camera, joist detector or any other suitable detector. Encoder 36′ is shown coupled to shaft 100 and wheel(s) 36 and grounded with respect to frame 26 and in conjunction with local controller 48′ measures distance, in one or more directions. In alternate embodiments, encoder 36′ may be provided on a separate wheel or may be any suitable position detection device, for example, a camera, optical detector or any suitable position detection device. System 10 may have a user interface 58 having a display and/or input and may have LPS 60. In alternate embodiments, more or less functions may be provided.

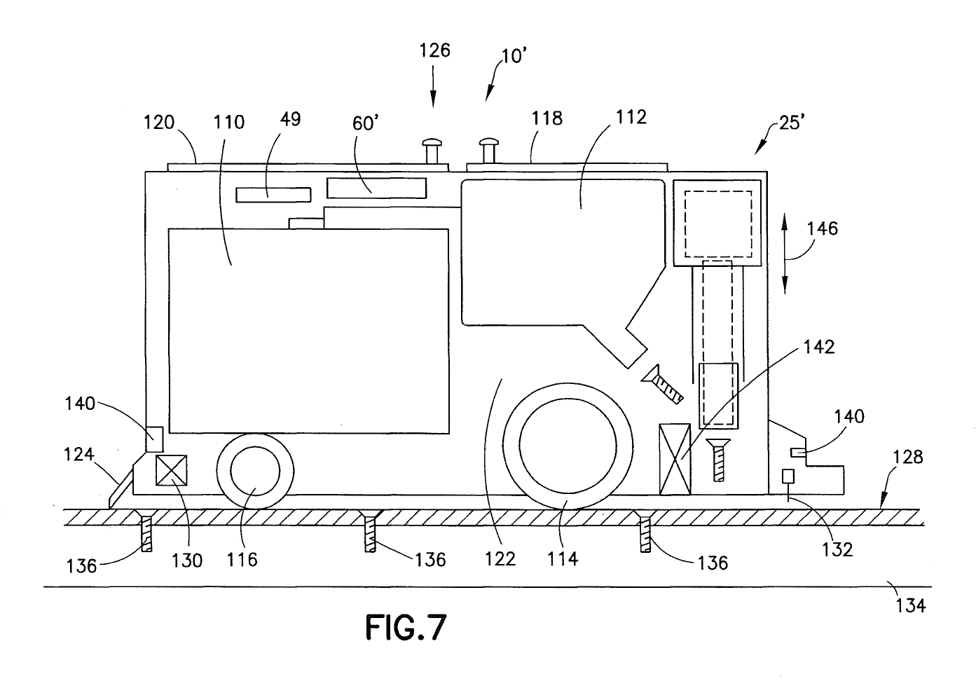

Referring now to FIG. 7, there is shown a side view of an alternate embodiment construction fastening system 10′. In the embodiment shown, fastening system 10′ may be autonomous acting independently and in conjunction with server 48 or semi autonomous acting in conjunction with a human operator and server 48. System 10′ has power source 110, controller 49, LPS 60′, screw gun or screw insertion portion 25′, fastener reservoir portion 112, drive wheels 114, trailing wheels 116 and service hatches 118, 120. In the embodiment shown, system 10′ is shown approximately six inches tall. In alternate embodiments, system 10′ may be taller or shorter or be any suitable shape or size. Vacuum source 122 may be used in conjunction with skirt 124 to apply down force 126 to house floor, wall, roof, sheathing or otherwise. Here, additional force may be applied to maintain a safety factor with respect to the friction of the casters and the angle applied to hold system 10′ to sheathing 128. A low vacuum sensor 130 may be used to determine state of the vacuum to determine safety factor and if an error is present. Joist sensor 132 may be provided to positively locate joist 134 to be fastened using screws 136 and may be sonic or any other suitable sensing. Line tracking or obstacle detection devices 140 may be provided on the front, side or any suitable location. Auto fed nailer, screwdriver to other suitable fastening device 25′ may be used as is needed for construction of structures. For example, fastening device 25′ may be a welder or other suitable fastening device. Drive wheels 114 may be driven independently with motors, gear motors or otherwise and having position feedback. Encoder(s) 116′ may be provided with wheels 116 to provide additional position feedback to controller 49. LPS 60′ may be provided and used in conjunction with server 48, local position feedback and local material or position references to locate system 10′. Fastening system 25′ may be laterally moveable perpendicular to the direction of travel on slide actuator 142 for fine positioning of system 25′ with respect to the line of fastening where actuator 142 laterally positions fastening system 25′ prior to insertion 146 of fastener 136. In alternate embodiments, more or less functions may be provided.

Referring now to FIG. 8, there is shown a diagram of a locating and tracking system or LPS 60. Location or tracking device 60 may be fixed to system 10 as shown in FIG. 1, to system 10′ as shown in FIG. 7 or alternately may be fixed to any suitable other personnel, material, tool, equipment or system within the construction site or being supplied to the construction site, for example, tools, fasteners, building materials, completed panels or structures assets or otherwise. Location device 60 may have any suitable combination of sensors or devices, for example, 6 axis accelerometer 160, 3 axis gyroscope 162, cpu 164, memory 166, power source 168 one or more cameras 170, 172, laser 174, bar code reader 176, hall detection device 178 and radio frequency identification device 180. The location device may have any suitable communication capability 182, such as with bluetooth, WIFI, radio, cellular or other suitable communication device. The module 60 may be provided on a single pc board or as multiple integrated components. In the embodiment shown, accuracy of +/− one inch may be provided for two minutes over thirty feet where system 60 is operated independently. In alternate embodiments, more or less accuracy may be provided depending on component precision. In alternate embodiments, more or less components may be provided on device 60. In the embodiment shown, additional accuracy is provided with interaction with server 48 and by leveraging knowledge of the use case in commercial and residential construction. For example, additional accuracy may be obtained by applying knowledge that from time to time system 10 stops and by system 60 knowing the use case, system 60 is aware that drift is unlikely. As such, system 60 may ignore in software any drift when such a known condition exists By way of further example, using dynamic landmarks fed back from system 48 to LPS 60, LPS 60 may be aware of what has been placed and by virtue of cad and server data, may be aware of what suppliers material is placed and, as such, may use known marks on the materials as landmarks, for example, known lines on a known manufacturers sheathing to provide nailing locations to controller 48′ of system 10. In application, the independent accuracy of the LPS used in combination with data collected by LPS 60 from known landmarks and from server 48 or otherwise may yield improved accuracy, for example, may give +/−0.030″ accuracy where the travel distance from landmark to landmark may be small or otherwise. In alternate embodiments, any suitable accuracy may be obtained with the combination of local data acquisition, applied knowledge of the use case (residential or commercial construction) and applied knowledge of data available from server 48. By way of further example, on tools, such as system 10, the gyroscope(s) may have anomalies when nailing. As the software in LPS 10 is aware when system 10 stopped and nailed, LPS 10 may ignore any data that would indicate drift or otherwise during the nailing event. In alternate embodiments, LPS 60 may be put on other tools, materials or workers such that system 10 or other material or tools may stay clear and avoid safety issues or otherwise. For example, LPS 60 may be put on the end of a crane, to deliver loads where planned. In alternate embodiments, any suitable combination of LPS(s) may be provided on any suitable combination of tools material or other assets used in commercial or residential construction and used in conjunction with server 48. In alternate embodiments, LPS(s) may be applied within any suitable use case in conjunction with or separate form commercial or residential construction.

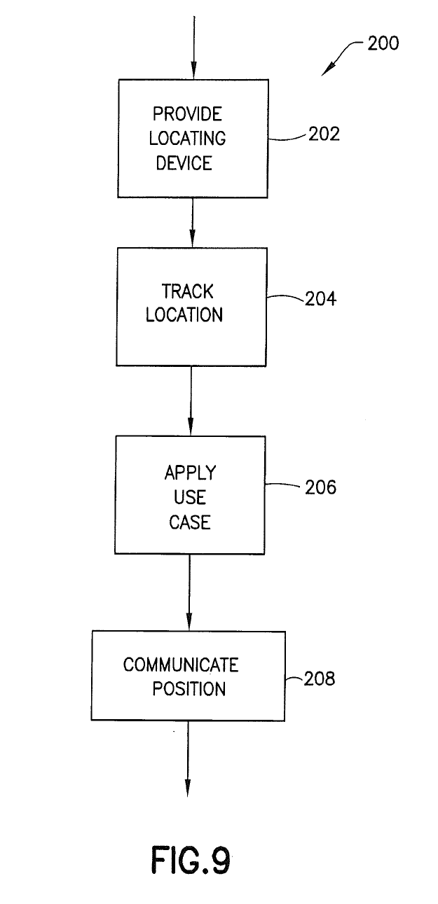

Referring now to FIG. 9 there is shown process flow diagram 200 showing a method of building a structure at a job site. The method of building has step 202 of providing a locating device on one or more of a tool, construction material or worker. A step 204 of tracking the location of the one or more of a tool, construction material or worker with the tracking device is provided. A step 206 of applying a construction use case to update the position of the tracking device is provided. A step 208 of communicating the position of the tracking device to a server is provided.

In accordance with one exemplary embodiment, a construction fastening system is provided adapted to fasten sheathing to framing with one or more fasteners. The fastening system has a frame and a fastening actuator coupled to the frame. The fastening actuator has a fastener reservoir portion and a fastener insertion portion. A position detector is coupled to the frame, the position detector connected to a controller, the position detector adapted to detect a position of the system. A trigger is coupled to the fastening actuator, the trigger coupled to the controller. The fastening actuator is adapted to insert a fastener from the reservoir into the sheathing upon actuation of the trigger. The controller is adapted to actuate the trigger upon detection of a predetermined change in the position of the system.

In accordance with another exemplary embodiment, a construction fastening system is provided adapted to fasten sheathing to framing with one or more fasteners. The fastening system has a frame and a fastening actuator coupled to the frame. The fastening actuator has a fastener reservoir portion and a fastener insertion portion. A position detector is coupled to the frame, the position detector connected to a controller, the position detector adapted to detect a position of the system. A trigger is coupled to the fastening actuator, the trigger coupled to the controller. The controller responsive to and in communication with an operator remote from the system. The fastening actuator is adapted to insert a fastener from the reservoir into the sheathing upon actuation of the trigger. The controller is adapted to actuate the trigger upon detection of a predetermined change in the position of the system.

In accordance with an exemplary method, a method of building a structure at a job site is provided. The method of building has a step of providing a locating device on one or more of a tool, construction material or worker. A step of tracking the location of the one or more of a tool, construction material or worker with the locating device is provided. A step of applying a construction use case to update the position of the tracking device is provided. A step of communicating the position of the locating device to a server is then provided.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances.

What is claimed is:

1. A construction fastening system adapted to fasten sheathing to framing with one or more fasteners, the fastening system comprising:
a frame and a fastening actuator coupled to the frame;
the fastening actuator having a fastener reservoir portion and a fastener insertion portion;
a position detector coupled to the frame, the position detector connected to a controller, the position detector adapted to detect a position of the system; and
a trigger coupled to the fastening actuator, the trigger coupled to the controller;
wherein the fastening actuator is adapted to insert a fastener from the reservoir into the sheathing upon actuation of the trigger and wherein the controller is adapted to actuate the trigger upon detection of a predetermined change in the position of the system.

2. The construction fastening system of claim 1 further comprising a slide shoe coupled to the frame, wherein when the slide shoe contacts the sheathing, the fastening actuator is properly positioned with respect to the sheathing.

3. The construction fastening system of claim 1 wherein the predetermined change in position is user selectable.

4. The construction fastening system of claim 1 wherein the predetermined change in position may comprise a sequence of intervals.

5. The construction fastening system of claim 1 wherein the position detector comprises an encoder.

6. The construction fastening system of claim 1 further comprising a tracking device adapted to track a fiducial on the sheathing.

7. The construction fastening system of claim 1 further comprising a joist sensor adapted to detect a joist below the sheathing.

8. A construction fastening system adapted to fasten sheathing to framing with one or more fasteners, the fastening system comprising:
a frame and a fastening actuator coupled to the frame;
the fastening actuator having a fastener reservoir portion and a fastener insertion portion;
a position detector coupled to the frame, the position detector connected to a controller, the position detector adapted to detect a position of the system;
the controller responsive to and in communication with an operator remote from the system; and
a trigger coupled to the fastening actuator, the trigger coupled to the controller;
wherein the fastening actuator is adapted to insert a fastener from the reservoir into the sheathing upon actuation of the trigger and wherein the controller is adapted to actuate the trigger upon detection of a predetermined change in the position of the system.

9. The construction fastening system of claim 8 further comprising a power source coupled to the frame.

10. The construction fastening system of claim 8 wherein the predetermined change in position is user selectable.

11. The construction fastening system of claim 8 wherein the predetermined change in position may comprise a sequence of intervals.

12. The construction fastening system of claim 8 wherein the position detector comprises an encoder.

13. The construction fastening system of claim 8 further comprising a tracking device adapted to track a fiducial on the sheathing. The construction fastening system of claim 8 further comprising a joist sensor adapted to detect a joist below the sheathing.

14. A method of building a structure at a job site, the method comprising:
providing a locating device on one or more of a tool, construction material or worker;
tracking the location of the one or more of a tool, construction material or worker with the locating device;
applying a construction use case to update the position of the tracking; and
communicating the position of the locating device to a server.

15. The method of claim 14 wherein the locating device may detect a location of a landmark.

16. The method of claim 14 wherein the server track multiple locating devices.

17. The method of claim 14, wherein the locating device may comprise a camera.

18. The method of claim 14 wherein the locating device may comprise a bar code reader.

19. The method of claim 14 wherein the locating device may apply knowledge of the use case in determining the position of the locating device.

20. The method of claim 14, wherein the locating device may detect a fiducial of building material.
